(19) United States
(12) Patent Application Publication
(10) Pub. No.: US 2022/0138666 A1
(43) Pub. Date: May 5, 2022

(54) AUTOMATED SCHEDULING OF VEHICLE REPAIR REINSPECTIONS

(71) Applicant: Mitchell International, Inc., San Diego, CA (US)

(72) Inventors: Vinod Yachareni, San Diego, CA (US); Bryan Durant, San Diego, CA (US); Hui Xu, San Diego, CA (US)

(73) Assignee: Mitchell International, Inc., San Diego, CA (US)

(21) Appl. No.: 17/088,341

(22) Filed: Nov. 3, 2020

(51) Int. Cl. G06Q 10/06; G06Q 10/00; G06Q 30/02; G06Q 10/10

(52) U.S. Cl. CPC G06Q 10/063116; G06Q 10/20; G06Q 30/0278; G06Q 40/08; G06Q 30/0205; G06Q 10/063112; G06Q 10/1097

(57) ABSTRACT

Systems, non-transitory machine-readable storage media, and computer-implemented methods are provided for automated scheduling of vehicle repair reinspections. In general, one aspect disclosed features a computer-implemented method comprising: obtaining an appraisal schedule that includes a plurality of appraisal appointments for appraisers, wherein each appointment identifies one of the appraisers, a vehicle repair to be appraised; receiving a reinspection notification that identifies a vehicle repair to be reinspected, a vehicle repair facility, and a duration for the reinspection; identifying availabilities in the appraisal schedule; selecting one of the availabilities in the appraisal schedule according to a predetermined assignment profile; modifying the appraisal schedule to schedule the reinspection during the selected availability, and sending an electronic message to an electronic device associated with the corresponding vehicle repair facility, wherein the electronic message identifies the vehicle repair to be reinspected, and the time of selected availability for the reinspection.

### CROSS REFERENCE TO RELATED APPLICATIONS

The present application is related to U.S. patent application Ser. No. 17/088,374, filed on Nov. 3, 2020, entitled “AUTOMATED SELECTION OF VEHICLE REPAIRS FOR REINSPECTION” [MITCH-APD-00041 (13CN-321137)], the disclosure thereof incorporated by reference herein in its entirety.

### BACKGROUND

The disclosed technology relates generally to systems for vehicle repair workflows, and more particularly, some embodiments relate to automation of those workflows.

### SUMMARY

A claimed solution rooted in computer technology overcomes problems specifically arising in the realm of computer technology.

In general, one aspect disclosed features a system, comprising: a hardware processor; and a non-transitory machine-readable storage medium encoded with instructions executable by the hardware processor to perform a method comprising: obtaining an appraisal schedule for a plurality of appraisers, wherein the appraisal schedule includes a plurality of appraisal appointments, and wherein each of the appraisal appointments identifies one of the appraisers, a vehicle repair to be appraised, and at least two of a start time for an appraisal of the vehicle repair to be appraised, a duration for the appraisal, and an end time for the appraisal; receiving a reinspection notification, wherein the reinspection notification identifies a vehicle repair to be reinspected, a vehicle repair facility where the reinspection is to take place, and a duration for a reinspection of the vehicle repair to be reinspected; identifying availabilities in the appraisal schedule, wherein each of the availabilities represents an interval during which the appraiser is available to perform the reinspection, and wherein each of the availabilities has a respective duration; selecting one of the availabilities in the appraisal schedule according to a predetermined assignment profile; modifying the appraisal schedule to schedule the reinspection during the selected availability, and sending an electronic message to an electronic device associated with the corresponding vehicle repair facility, wherein the electronic message identifies the vehicle repair to be reinspected, and the time of selected availability for the reinspection.

Embodiments of the system may include one or more of the following features. In some embodiments, selecting one of the availabilities in the appraisal schedule according to a predetermined assignment profile comprises: identifying geographic locations of the appraisal appointments that are in temporal proximity to the availabilities; and selecting one of the availabilities according to the geographic locations and the location of the vehicle repair facility. In some embodiments, selecting one of the availabilities in the appraisal schedule according to a predetermined assignment profile comprises: selecting the availabilities according to the corresponding appraisers in a round robin technique. In some embodiments, selecting one of the availabilities in the appraisal schedule according to a predetermined assignment profile comprises: selecting one of the appraisers; and selecting one of the availabilities of the selected appraiser. In some embodiments, the method further comprises: selecting availabilities of the selected appraiser for until all of the availabilities of the selected appraiser have been selected; and modifying the appraisal schedule to schedule reinspections during the selected availabilities. In some embodiments, selecting one of the availabilities in the appraisal schedule according to a predetermined assignment profile comprises: selecting only those availabilities corresponding to appraisers assigned to a territory in which the vehicle repair facility is located. In some embodiments, selecting one of the availabilities in the appraisal schedule according to a predetermined assignment profile comprises: selecting only those availabilities corresponding to appraisers having expertise required to perform the reinspection.

In general, one aspect disclosed features a non-transitory machine-readable storage medium encoded with instructions executable by a hardware processor of a computing component, the machine-readable storage medium comprising instructions to cause the hardware processor to perform a method comprising: obtaining an appraisal schedule for a plurality of appraisers, wherein the appraisal schedule includes a plurality of appraisal appointments, and wherein each of the appraisal appointments identifies one of the appraisers, a vehicle repair to be appraised, and at least two of a start time for an appraisal of the vehicle repair to be appraised, a duration for the appraisal, and an end time for the appraisal; receiving a reinspection notification, wherein the reinspection notification identifies a vehicle repair to be reinspected, a vehicle repair facility where the reinspection is to take place, and a duration for a reinspection of the vehicle repair to be reinspected; identifying availabilities in the appraisal schedule, wherein each of the availabilities represents an interval during which the appraiser is available to perform the reinspection, and wherein each of the availabilities has a respective duration; selecting one of the availabilities in the appraisal schedule according to a predetermined assignment profile; modifying the appraisal schedule to schedule the reinspection during the selected availability, and sending an electronic message to an electronic device associated with the corresponding vehicle repair facility, wherein the electronic message identifies the vehicle repair to be reinspected, and the time of selected availability for the reinspection.

Embodiments of the non-transitory machine-readable storage medium may include one or more of the following features. In some embodiments, selecting one of the availabilities in the appraisal schedule according to a predetermined assignment profile comprises: identifying geographic locations of the appraisal appointments that are in temporal proximity to the availabilities; and selecting one of the availabilities according to the geographic locations and the location of the vehicle repair facility. In some embodiments, selecting one of the availabilities in the appraisal schedule according to a predetermined assignment profile comprises: selecting the availabilities according to the corresponding appraisers in a round robin technique. In some embodiments, selecting one of the availabilities in the appraisal schedule according to a predetermined assignment profile comprises: selecting one of the appraisers; and selecting one of the availabilities of the selected appraiser. In some embodiments, the method further comprises: selecting availabilities of the selected appraiser for until all of the availabilities of the selected appraiser have been selected; and modifying the appraisal schedule to schedule reinspections during the selected availabilities. In some embodiments, selecting one of the availabilities in the appraisal schedule according to a predetermined assignment profile comprises: selecting only those availabilities corresponding to appraisers assigned to a territory in which the vehicle repair facility is located. In some embodiments, selecting one of the availabilities in the appraisal schedule according to a predetermined assignment profile comprises: selecting only those availabilities corresponding to appraisers having expertise required to perform the reinspection.

In general, one aspect disclosed features a computer-implemented method comprising: obtaining an appraisal schedule for a plurality of appraisers, wherein the appraisal schedule includes a plurality of appraisal appointments, and wherein each of the appraisal appointments identifies one of the appraisers, a vehicle repair to be appraised, and at least two of a start time for an appraisal of the vehicle repair to be appraised, a duration for the appraisal, and an end time for the appraisal; receiving a reinspection notification, wherein the reinspection notification identifies a vehicle repair to be reinspected, a vehicle repair facility where the reinspection is to take place, and a duration for a reinspection of the vehicle repair to be reinspected; identifying availabilities in the appraisal schedule, wherein each of the availabilities represents an interval during which the appraiser is available to perform the reinspection, and wherein each of the availabilities has a respective duration; selecting one of the availabilities in the appraisal schedule according to a predetermined assignment profile; modifying the appraisal schedule to schedule the reinspection during the selected availability, and sending an electronic message to an electronic device associated with the corresponding vehicle repair facility, wherein the electronic message identifies the vehicle repair to be reinspected, and the time of selected availability for the reinspection.

Embodiments of the computer-implemented method may include one or more of the following features. In some embodiments, selecting one of the availabilities in the appraisal schedule according to a predetermined assignment profile comprises: identifying geographic locations of the appraisal appointments that are in temporal proximity to the availabilities; and selecting one of the availabilities according to the geographic locations and the location of the vehicle repair facility. In some embodiments, selecting one of the availabilities in the appraisal schedule according to a predetermined assignment profile comprises: selecting the availabilities according to the corresponding appraisers in a round robin technique. In some embodiments, selecting one of the availabilities in the appraisal schedule according to a predetermined assignment profile comprises: selecting one of the appraisers; and selecting one of the availabilities of the selected appraiser. Some embodiments comprise: selecting availabilities of the selected appraiser for until all of the availabilities of the selected appraiser have been selected; and modifying the appraisal schedule to schedule reinspections during the selected availabilities. In some embodiments, selecting one of the availabilities in the appraisal schedule according to a predetermined assignment profile comprises at least one of: selecting only those availabilities corresponding to appraisers assigned to a territory in which the vehicle repair facility is located; or selecting only those availabilities corresponding to appraisers having expertise required to perform the reinspection.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates a vehicle repair reinspection scheduling system according to some embodiments of the disclosed technology.

FIG. 2 illustrates a process for vehicle repair workflow according to some embodiments of the disclosed technology.

FIG. 3 illustrates a process for automated vehicle repair reinspection scheduling according to some embodiments of the disclosed technology.

FIG. 4 illustrates an example appraisal schedule according to embodiments of the disclosed technology.

FIG. 5 illustrates an example appraisal/reinspection schedule with reinspections assigned according to some embodiments of the disclosed technology.

FIG. 6 illustrates an example graphical user interface that may be generated during configuration according to some embodiments of the disclosed technology.

FIG. 7 is an example computing component that may be used to implement various features of embodiments described in the present disclosure.

The figures are not exhaustive and do not limit the present disclosure to the precise form disclosed.

### DETAILED DESCRIPTION

Safe and proper vehicle collision repairs are priorities for insurance carriers and their policy holders. To ensure that vehicle repairs are done with the highest quality, insurance carriers want to physically inspect the vehicle prior to and/or during the repair process; this process is known as a “Reinspection”. If problems are found during reinspection, the carrier can work with the repair facility to correct the problems before the vehicle is returned to the customer. This process also enables the carrier to work proactively with the repair facility on their quality processes to help prevent problems in the future.

Reinspections are generally carried out by appraisers, who spend most of their time conducting initial inspections, also known as appraisals, of vehicle damage. One problem that arises with re-inspections is how to assign both appraisals and reinspections to appraisers in an efficient manner. For example, reinspections may be assigned to appraisers having schedule availabilities, appraisers who may be near the vehicle repair facility where the reinspection will take place, appraisers with particular expertise, and the like.

Before describing embodiments of the disclosed technology in detail, it is useful to describe an example environment in which the disclosed technology may be implemented.

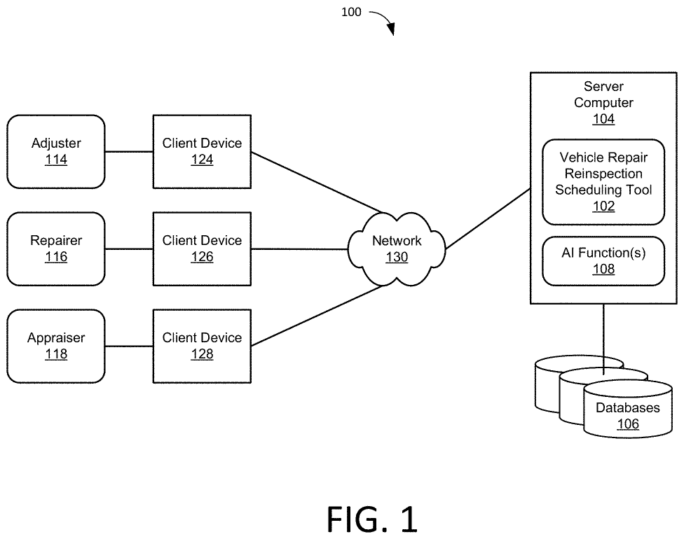

FIG. 1 illustrates a vehicle repair reinspection scheduling system 100 according to some embodiments of the disclosed technology. Multiple users may be involved in the vehicle repair workflow. For example, referring to FIG. 1, the users may include a claims adjuster 114, a repairer 116 such as an employee of a repair facility, an appraiser 118, and the like. Each user may employ a respective client device 124, 126, 128. Each client device may be implemented as a desktop computer, laptop computer, smart phone, smart glasses, embedded computers and displays, diagnostic devices and the like.

The system 100 may include a vehicle repair reinspection scheduling tool 102, which may be implemented as one or more software packages executing on one or more server computers 104. Each user may employ a respective client device 124, 126, 128 to access the tool 102 over a network 130 such as the Internet.

The tool 102 may include a plurality of AI functions 108. The AI functions 108 may be implemented in any manner. For example, one or more of the AI functions 108 may be implemented as trained machine learning models. The machine learning models may include computer vision machine learning models, natural language processing machine learning models, and the like.

The system 100 may include one or more databases 106, which may store vehicle repair reinspection schedules, appraiser information, locations of vehicle repair facilities, and the like.

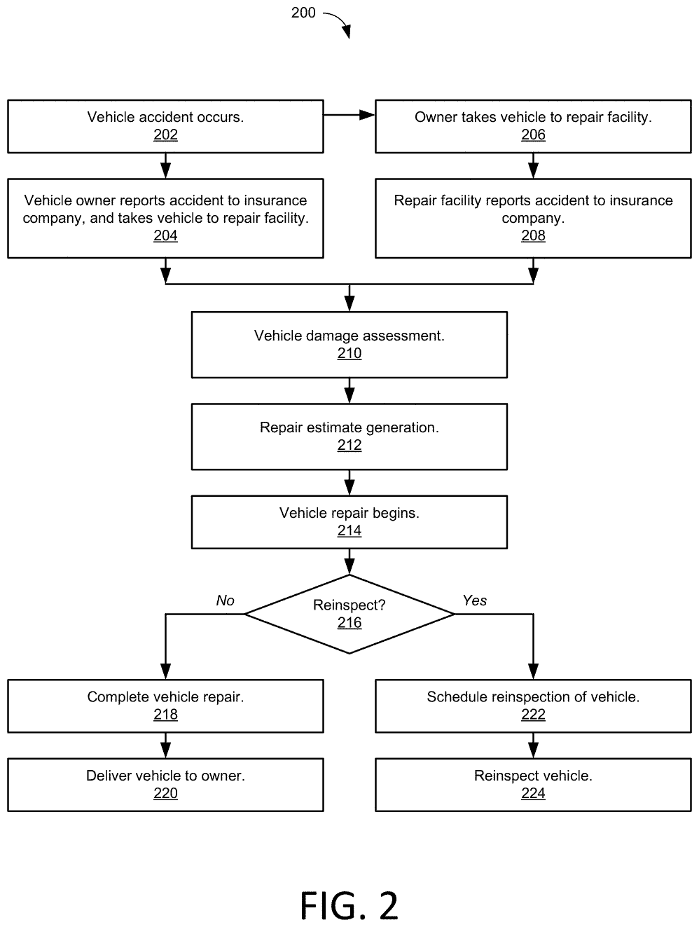

FIG. 2 illustrates a process 200 for vehicle repair workflow according to some embodiments of the disclosed technology. The elements of the disclosed processes are presented in a particular order. However, it should be understood that, in various embodiments, one or more elements may be performed in a different order, in parallel, or omitted. Portions of the disclosed processes may be performed using artificial intelligence functions. For example, referring again to FIG. 1, these portions may be performed by AI functions 108.

Referring to FIG. 2, the process 200 may begin with a vehicle accident, at 202, and may continue with the vehicle owner reporting the accident to an insurance company, and taking the vehicle to a repair facility, at 204. Alternatively, the owner may take the vehicle to a repair facility, at 206, which may report the accident to the insurance company, at 208.

Next, a vehicle damage assessment is performed, at 210. For example, a staff appraiser of an insurance company may visit the damaged vehicle to take photos of the damage. Alternatively, the owner may send photos of the damaged vehicle to the insurance company. Next, the process may include the generation of a vehicle repair estimate, at 212. Based on the vehicle repair estimate, the repair of the vehicle may begin, at 214.

Before or during the repair, the vehicle repair reinspection scheduling tool 102 may make a decision to reinspect the vehicle and/or vehicle repair, at 216. When a decision is made not to reinspect, the vehicle repair may be completed, at 218. When the repair is complete, the repaired vehicle may be delivered to the vehicle owner, at 220.

When a decision is made to reinspect, the reinspection may be scheduled, at 222, as described in detail herein. After the reinspection is scheduled, the vehicle may be reinspected, at 222. For example, the insurance carrier may dispatch an appraiser to the repair facility to reinspect the vehicle. When a problem is discovered during reinspection, the insurance carrier may help the repair facility remedy the problem, for example by revising the repair estimate, ordering further repairs, modifying the facilities repair, estimate, and quality processes, and the like.

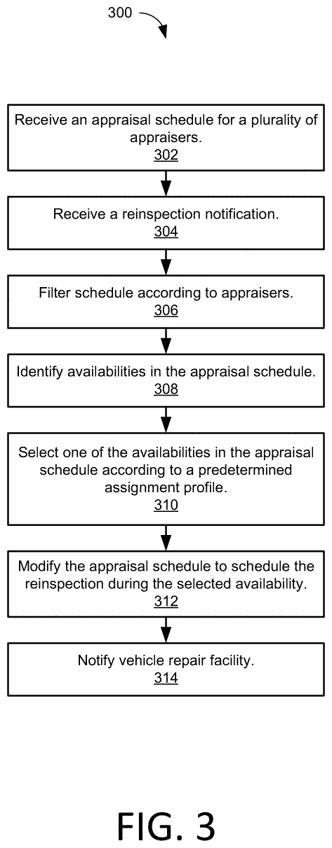

FIG. 3 illustrates a process 300 for automated vehicle repair reinspection scheduling according to some embodiments of the disclosed technology. The process 300 may be performed, entirely or in part, by the vehicle repair reinspection scheduling tool 102 of FIG. 1.

Referring to FIG. 3, the process 300 may begin with obtaining an appraisal schedule for a plurality of appraisers, at 302. For example, referring again to FIG. 1, the appraisal schedule may be stored in the databases 106, and the vehicle repair reinspection scheduling tool 102 may obtain an appraisal schedule from the databases 106. The appraisal schedule may include a plurality of appraisal appointments. Each of the appraisal appointments may identify one of the appraisers, a vehicle repair to be appraised, and schedule information for the appraisal appointment. For example, the schedule information may include a start time for an appraisal of the vehicle repair to be appraised, a duration for the appraisal, an end time for the appraisal, and the like.

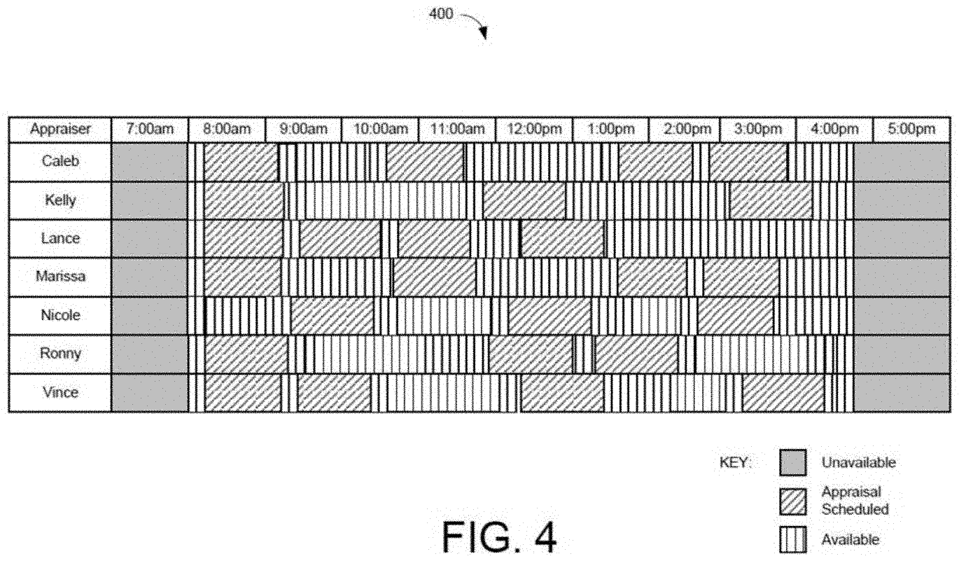

FIG. 4 illustrates an example appraisal schedule 400 according to embodiments of the disclosed technology. Referring to FIG. 4, the appraisal schedule 400 includes schedules for several appraisers for a particular day. Referring to the key in FIG. 4, the schedule shows time slots where an appraiser is unavailable in grey, time slots where an appraiser has an appraisal scheduled in diagonal crosshatch, and time slots where an appraiser is available for a reinspection in vertical crosshatch. As used herein, the term “availability” refers to an interval during which an appraiser is available to perform a reinspection. Each of the availabilities may have a respective duration.

Referring again to FIG. 3, the process 300 may include receiving a reinspection notification, at 304. For example, referring again to FIG. 1, the reinspection notification may be received from any of the client devices 124, 126, 128. In some embodiments, the reinspection notification may be received from a vehicle repair reinspection tool, for example as described in the related application cited above. The reinspection notification may identify a vehicle repair to be reinspected, a vehicle repair facility where the reinspection is to take place, a duration for a reinspection of the vehicle repair to be reinspected, and the like. In some embodiments, the tool 102 may receive the vehicle repair estimate, which may serve as the notification.

Referring again to FIG. 3, the process 300 may include filtering the appraisal schedule according to the appraisers, at 306. For example, referring again to FIG. 1, the vehicle repair reinspection scheduling tool 102 may filter the schedule. In some embodiments, appraisers may be assigned to different territories. In such embodiments, appraisers who do not have the vehicle repair facility in their territories may be filtered out. In some embodiments, appraisers may have different expertise. In such embodiments, appraisers who do not have the expertise required for the reinspection may be filtered out.

In some embodiments, appraisers may have assignment restrictions. For example, each appraiser may have a list of “restricted locations” (at an address, a city, or a state level) which will prevent the appraiser from getting assignments\reinspection tasks at locations that match any of the appraiser's restricted locations. For example, Company A may want to prevent Appraiser 3 from visiting a repair facility because the owner of the repair facility may know Appraiser 3 and there could be a conflict of interest. Or perhaps Company A wants to prevent more junior appraisers from visiting certain repair facilities or even certain cities. In such embodiments, appraisers who are restricted from performing the reinspection may be filtered out.

Referring again to FIG. 3, the process 300 may include identifying availabilities in the appraisal schedule, at 308. For example, referring again to FIG. 1, the vehicle repair reinspection scheduling tool 102 may identify availabilities in the appraisal schedule. In the example of FIG. 4, each appraiser has at least one availability.

Referring again to FIG. 3, the process 300 may include selecting one of the availabilities in the appraisal schedule according to a predetermined assignment profile, at 310. For example, referring again to FIG. 1, the vehicle repair reinspection scheduling tool 102 may select one of the availabilities in the appraisal schedule according to the predetermined assignment profile. The predetermined assignment profile may be determined during configuration of the vehicle repair reinspection scheduling tool 102.

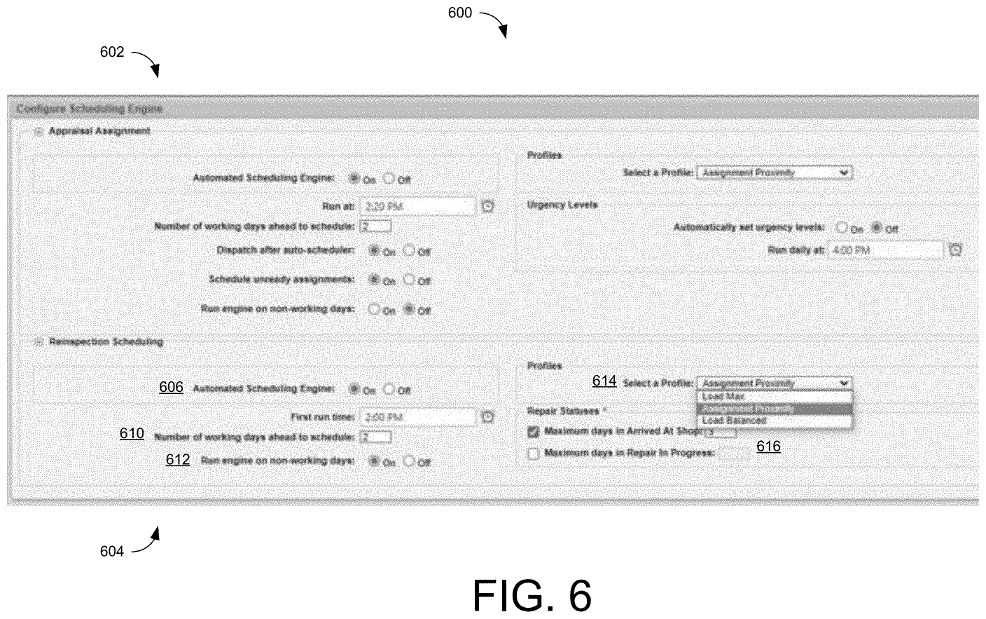

FIG. 6 illustrates an example graphical user interface 600 that may be generated during configuration according to some embodiments of the disclosed technology. For example, referring again to FIG. 1, the example graphical user interface 600 may be generated by the vehicle repair reinspection scheduling tool 102.

Referring to FIG. 6, the graphical user interface 600 may be used to configure both the scheduling of appraisals, at 602, and the scheduling of reinspections, at 604. The graphical user interface 600 may allow a user to turn automated reinspection scheduling on and off, at 606, and to set the first run time of the day, at 608. The graphical user interface 600 may allow a user to set the number of working days ahead to schedule, at 610, and whether to run automated reinspection scheduling on non-working days, at 612. The graphical user interface 600 may allow a user to set repair statuses of the vehicle, at 614, for example as described in the related application cited above. The graphical user interface 600 may allow a user to select one of a plurality of profiles, at 616. In the example of FIG. 6, the profiles may include Load Max, Assignment Proximity, and Load Balanced. However, any suitable profile may be used.

The Load Max profile may be used to fill the schedule of a selected appraiser with reinspections before selecting another appraiser. For example, the Load Max profile may configure the vehicle repair reinspection scheduling tool 102 to select one of the appraisers, select one of the availabilities of the selected appraiser, modify the appraisal schedule to schedule the reinspection during the selected availability, select a second availability of the selected appraiser, modify the appraisal schedule to schedule a second reinspection during the selected second availability, and so on, until all of the availabilities of the selected appraiser have been selected and filled.

The Assignment Proximity profile may be used to prioritize proximity of appraisers to vehicle repair shops. This profile may serve to minimize travel between vehicle repair facilities. For example, the Assignment Proximity profile may configure the vehicle repair reinspection scheduling tool 102 to identify geographic locations of the appraisal appointments that are in temporal proximity to the availabilities of the appraisers, and to select one of the availabilities according to the geographic locations and the location of the vehicle repair facility.

The Load Balanced profile may be used to distribute reinspections evenly among the appraisers. For example, the Load Balanced profile may configure the vehicle repair reinspection scheduling tool 102 to distribute the reinspections according to a load-balancing technique. In one example, the load-balancing technique may be a round robin technique.

Referring again to FIG. 3, the process 300 may include modifying the appraisal schedule to schedule the reinspection during the selected availability, at 312. For example, referring again to FIG. 1, the vehicle repair reinspection scheduling tool 102 may modify the appraisal schedule to schedule the reinspection during the selected availability.

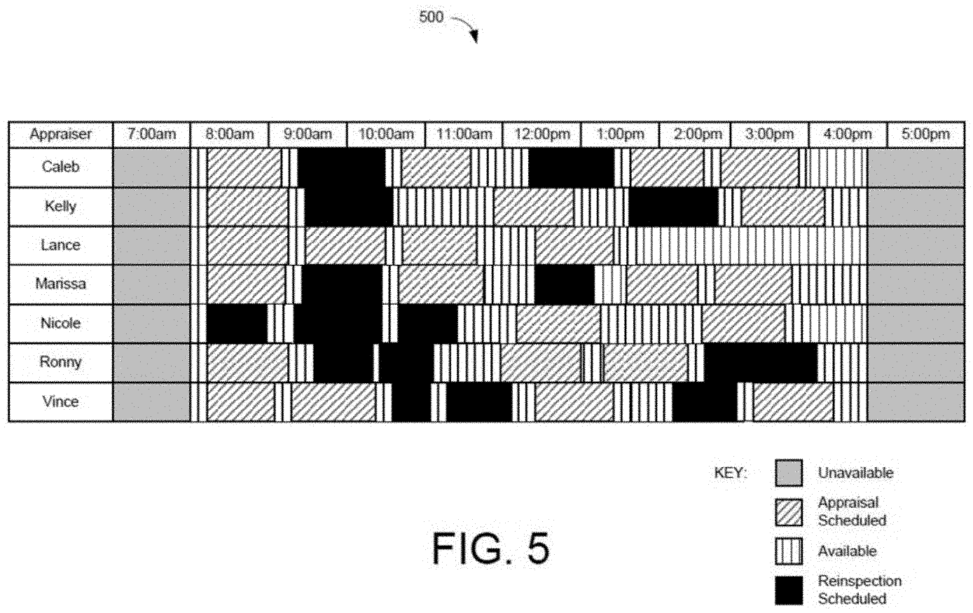

FIG. 5 illustrates an example appraisal/reinspection schedule 500 with reinspections assigned according to some embodiments of the disclosed technology. Referring to FIG. 5, the appraisal/reinspection schedule 500 is the same as the appraisal schedule 400 of FIG. 4, modified to include reinspection assignments. Referring to the key in FIG. 5, the appraisal/reinspection 500 shows time slots where an appraiser has a reinspection scheduled in black. In the example of FIG. 5, nearly all of the availabilities have been filled with reinspection appointments.

The appraisers may obtain the appraisal/reinspection schedules in any manner. In some embodiments, the appraisers may log in to the vehicle repair reinspection scheduling tool 102, and upon a successful login, may obtain their appraisal/reinspection schedule from the tool 102. In some embodiments, the appraisal/reinspection schedules may be pushed to the appraisers, for example by email, to a mobile app, and the like.

Referring again to FIG. 3, the process 300 may include notifying the vehicle repair facility of the scheduled reinspection appointment, at 314. These notifications may be provided to the vehicle repair facilities in the same manner the appraisal/reinspection schedules are provided to the appraisers.

Embodiments of the disclosed technology confer numerous benefits. One significant advantage is that now insurance carriers can cover both appraisal assignments and reinspection tasks with same set of staff appraisers in an optimized way while maximizing efficiency by automatically scheduling reinspection assignments. The disclosed technology requires little to no human involvement in scheduling reinspections. Manual scheduling of reinspections is no longer required.

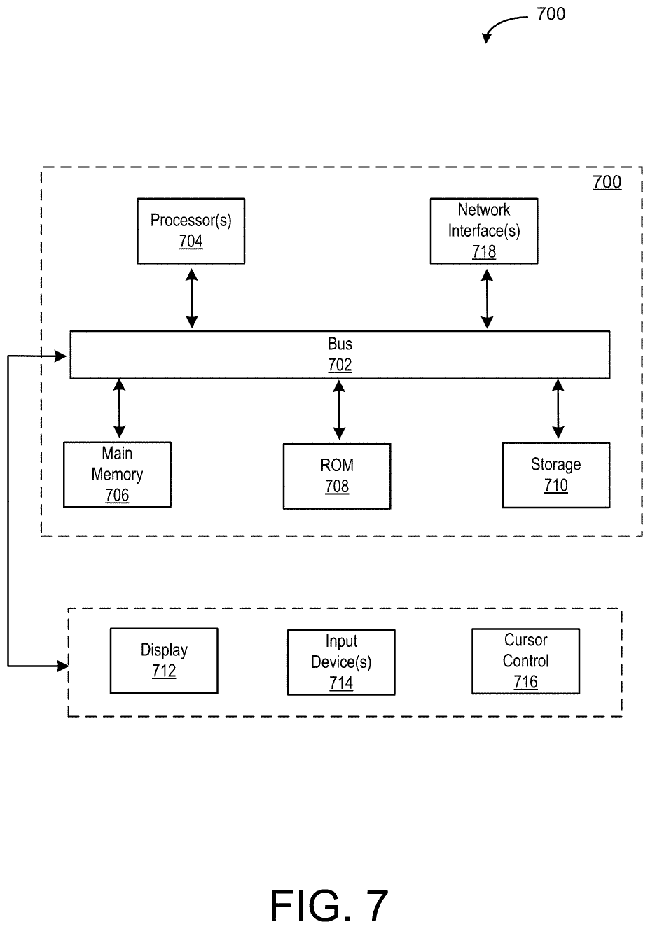

FIG. 7 depicts a block diagram of an example computer system 700 in which embodiments described herein may be implemented. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

The computer system 700 may be coupled via bus 702 to a display 712, such as a liquid crystal display (LCD) (or touch screen), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. In some embodiments, the same direction information and command selections as cursor control may be implemented via receiving touches on a touch screen without a cursor.

The computing system 700 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C, C++, and Python. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

The computer system 700 also includes a communication interface 718 coupled to bus 702. Network interface 718 provides a two-way data communication coupling to one or more network links that are connected to one or more local networks. For example, communication interface 718 may be an integrated services digital network (ISDN) card, cable modem, satellite modem, or a modem to provide a data communication connection to a corresponding type of telephone line. As another example, network interface 718 may be a local area network (LAN) card to provide a data communication connection to a compatible LAN (or a WAN component to communicate with a WAN). Wireless links may also be implemented. In any such implementation, network interface 718 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 718, which carry the digital data to and from computer system 700, are example forms of transmission media.

The computer system 700 can send messages and receive data, including program code, through the network(s), network link and communication interface 718. In the Internet example, a server might transmit a requested code for an application program through the Internet, the ISP, the local network and the communication interface 718.

The received code may be executed by processor 704 as it is received, and/or stored in storage device 710, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, or a combination of hardware and software. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 700.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system, comprising:
a hardware processor; and
a non-transitory machine-readable storage medium encoded with instructions executable by the hardware processor to perform a method comprising:
obtaining an appraisal schedule for a plurality of appraisers, wherein the appraisal schedule includes a plurality of appraisal appointments, and wherein each of the appraisal appointments identifies one of the appraisers, a vehicle repair to be appraised, and at least two of a start time for an appraisal of the vehicle repair to be appraised, a duration for the appraisal, and an end time for the appraisal;
receiving a reinspection notification, wherein the reinspection notification identifies a vehicle repair to be reinspected, a vehicle repair facility where the reinspection is to take place, and a duration for a reinspection of the vehicle repair to be reinspected;
identifying availabilities in the appraisal schedule, wherein each of the availabilities represents an interval during which the appraiser is available to perform the reinspection, and wherein each of the availabilities has a respective duration;
selecting one of the availabilities in the appraisal schedule according to a predetermined assignment profile;
modifying the appraisal schedule to schedule the reinspection during the selected availability, and
sending an electronic message to an electronic device associated with the corresponding vehicle repair facility, wherein the electronic message identifies the vehicle repair to be reinspected, and the time of selected availability for the reinspection.

2. The system of claim 1, wherein selecting one of the availabilities in the appraisal schedule according to a predetermined assignment profile comprises:
identifying geographic locations of the appraisal appointments that are in temporal proximity to the availabilities; and
selecting one of the availabilities according to the geographic locations and the location of the vehicle repair facility.

3. The system of claim 1, wherein selecting one of the availabilities in the appraisal schedule according to a predetermined assignment profile comprises:
selecting the availabilities according to the corresponding appraisers in a round robin technique.

4. The system of claim 1, wherein selecting one of the availabilities in the appraisal schedule according to a predetermined assignment profile comprises:
selecting one of the appraisers; and
selecting one of the availabilities of the selected appraiser.

5. The system of claim 4, the method further comprising:
selecting availabilities of the selected appraiser for until all of the availabilities of the selected appraiser have been selected; and
modifying the appraisal schedule to schedule reinspections during the selected availabilities.

6. The system of claim 1, wherein selecting one of the availabilities in the appraisal schedule according to a predetermined assignment profile comprises:
selecting only those availabilities corresponding to appraisers assigned to a territory in which the vehicle repair facility is located.

7. The system of claim 1, wherein selecting one of the availabilities in the appraisal schedule according to a predetermined assignment profile comprises:
selecting only those availabilities corresponding to appraisers having expertise required to perform the reinspection.

8. A non-transitory machine-readable storage medium encoded with instructions executable by a hardware processor of a computing component, the machine-readable storage medium comprising instructions to cause the hardware processor to perform a method comprising:
obtaining an appraisal schedule for a plurality of appraisers, wherein the appraisal schedule includes a plurality of appraisal appointments, and wherein each of the appraisal appointments identifies one of the appraisers, a vehicle repair to be appraised, and at least two of a start time for an appraisal of the vehicle repair to be appraised, a duration for the appraisal, and an end time for the appraisal;
receiving a reinspection notification, wherein the reinspection notification identifies a vehicle repair to be reinspected, a vehicle repair facility where the reinspection is to take place, and a duration for a reinspection of the vehicle repair to be reinspected;
identifying availabilities in the appraisal schedule, wherein each of the availabilities represents an interval during which the appraiser is available to perform the reinspection, and wherein each of the availabilities has a respective duration;
selecting one of the availabilities in the appraisal schedule according to a predetermined assignment profile;
modifying the appraisal schedule to schedule the reinspection during the selected availability, and
sending an electronic message to an electronic device associated with the corresponding vehicle repair facility, wherein the electronic message identifies the vehicle repair to be reinspected, and the time of selected availability for the reinspection.

9. The non-transitory machine-readable storage medium of claim 8, wherein selecting one of the availabilities in the appraisal schedule according to a predetermined assignment profile comprises:
identifying geographic locations of the appraisal appointments that are in temporal proximity to the availabilities; and
selecting one of the availabilities according to the geographic locations and the location of the vehicle repair facility.

10. The non-transitory machine-readable storage medium of claim 8, wherein selecting one of the availabilities in the appraisal schedule according to a predetermined assignment profile comprises:
selecting the availabilities according to the corresponding appraisers in a round robin technique.

11. The non-transitory machine-readable storage medium of claim 8, wherein selecting one of the availabilities in the appraisal schedule according to a predetermined assignment profile comprises:
selecting one of the appraisers; and
selecting one of the availabilities of the selected appraiser.

12. The non-transitory machine-readable storage medium of claim 11, the method further comprising:
selecting availabilities of the selected appraiser for until all of the availabilities of the selected appraiser have been selected; and
modifying the appraisal schedule to schedule reinspections during the selected availabilities.

13. The non-transitory machine-readable storage medium of claim 8, wherein selecting one of the availabilities in the appraisal schedule according to a predetermined assignment profile comprises:
selecting only those availabilities corresponding to appraisers assigned to a territory in which the vehicle repair facility is located.

14. The non-transitory machine-readable storage medium of claim 8, wherein selecting one of the availabilities in the appraisal schedule according to a predetermined assignment profile comprises:
selecting only those availabilities corresponding to appraisers having expertise required to perform the reinspection.

15. A computer-implemented method comprising:
obtaining an appraisal schedule for a plurality of appraisers, wherein the appraisal schedule includes a plurality of appraisal appointments, and wherein each of the appraisal appointments identifies one of the appraisers, a vehicle repair to be appraised, and at least two of a start time for an appraisal of the vehicle repair to be appraised, a duration for the appraisal, and an end time for the appraisal;
receiving a reinspection notification, wherein the reinspection notification identifies a vehicle repair to be reinspected, a vehicle repair facility where the reinspection is to take place, and a duration for a reinspection of the vehicle repair to be reinspected;
identifying availabilities in the appraisal schedule, wherein each of the availabilities represents an interval during which the appraiser is available to perform the reinspection, and wherein each of the availabilities has a respective duration;
selecting one of the availabilities in the appraisal schedule according to a predetermined assignment profile;
modifying the appraisal schedule to schedule the reinspection during the selected availability, and
sending an electronic message to an electronic device associated with the corresponding vehicle repair facility, wherein the electronic message identifies the vehicle repair to be reinspected, and the time of selected availability for the reinspection.

16. The computer-implemented method of claim 15, wherein selecting one of the availabilities in the appraisal schedule according to a predetermined assignment profile comprises:
identifying geographic locations of the appraisal appointments that are in temporal proximity to the availabilities; and
selecting one of the availabilities according to the geographic locations and the location of the vehicle repair facility.

17. The computer-implemented method of claim 15, wherein selecting one of the availabilities in the appraisal schedule according to a predetermined assignment profile comprises:
selecting the availabilities according to the corresponding appraisers in a round robin technique.

18. The computer-implemented method of claim 15, wherein selecting one of the availabilities in the appraisal schedule according to a predetermined assignment profile comprises:
selecting one of the appraisers; and
selecting one of the availabilities of the selected appraiser.

19. The computer-implemented method of claim 18, further comprising:
selecting availabilities of the selected appraiser for until all of the availabilities of the selected appraiser have been selected; and
modifying the appraisal schedule to schedule reinspections during the selected availabilities.

20. The computer-implemented method of claim 15, wherein selecting one of the availabilities in the appraisal schedule according to a predetermined assignment profile comprises at least one of:
selecting only those availabilities corresponding to appraisers assigned to a territory in which the vehicle repair facility is located; or
selecting only those availabilities corresponding to appraisers having expertise required to perform the reinspection.
